(19) United States
(12) Patent Application Publication
(10) Pub. No.: US 2006/0001725 A1
(43) Pub. Date: Jan. 5, 2006

(54) Ink jet recording medium

(75) Inventors: Kozo Nagata, Shizuoka-ken (JP); Kazuyuki Koike, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/171,471

(22) Filed: Jul. 1, 2005

(30) Foreign Application Priority Data
Jul. 2, 2004 (JP) 2004-197102

(51) Int. Cl. B41J 2/01

(52) U.S. Cl. 347/105

(57) ABSTRACT

The invention provides an inkjet recording medium where an ink receiving layer is provided on a support body. The ink receiving layer is formed from a coating liquid which includes at least one type of water soluble multi-valent metal salt, and at least a aqueous dispersion of a cation modified self-emulsifying polymer. The average particle size of the aqueous dispersion material is 0.05 μm or less.

### CROSS-REFERENCE TO RELATED APPLICATION

This application claims priority under 35USC119 from Japanese Patent Application No. 2004-197102, the disclosure of which is incorporated by reference herein.

### BACKGROUND OF THE INVENTION

1. Field of the Invention

This invention is related to an inkjet recording medium that has improved properties regarding the tendency to develop bleeding with the passing of time, and good surface condition.

2. Description of the Related Art

Recently, various information processing systems have been developed along with rapid development in the IT industry. Recording methods and devices suitable for these information processing systems have also been developed and variously put to practical use. Among the above-mentioned recording methods, ink jet recording methods can be used to record on many kinds of recording materials, and hardware (devices) therefor are comparatively low priced, compact, and very quiet. Therefore, the ink jet recording method has been widely used in the office as well as at home.

Further, various mediums for ink jet recording have been developed in recent years, and along with the achievement of high resolution ink jet printers and the development of hardware (devices), it has become possible to obtain so-called “photograph-like” high-quality recorded products.

In particular, examples of the properties required for the mediums for ink jet recording include (1) quick drying (high ink absorption speed), (2) ink dots having proper and uniform diameters (no bleeding), (3) excellent granularity, (4) high circularity of dots, (5) high color density, (6) high color saturation (no dullness), (7) excellent light fastness, and water resistance of printed portions, (8) a recording surface having a high degree of whiteness, (9) excellent storability of a recording medium (no yellow discoloration or image bleeding during long term storage), (10) resistance to deformation and excellent dimensional stability (sufficiently small curl), and (11) excellent running properties in hardware. Further, in addition to the above-mentioned properties, glossiness, surface flatness and texture similar to that of a silver salt photograph are required for use as photographic glossy paper used to obtain photograph-like high-quality recorded products.

In order to improve the various above properties, inkjet recording media with ink receiving layers of a porous structure have been developed for practical use. In the inkjet recording media, by using porous structures, high gloss with superior ink receivability (dryability) can be achieved.

For example, ink jet recording media have been proposed that include trace amounts of inorganic pigments, and water soluble resins, and have high void ratio ink receiving layers provided on a support body (see, for example, Japanese Patent Application Laid-Open (JP-A) Nos. 10-119423 and 10-217601). These inkjet recording media have an ink receiving layer formed on a recording sheet with a porous structure using particularly inorganic pigment fine particles. Such structures have superior ink absorption ability, and make it possible to both obtain an ink receiving layer on which high definition images can be formed and which has high gloss.

Further, in order to fix dye components in inks the addition to inkjet recording sheets of compounds with primary, secondary and tertiary amine groups or quaternary ammonium salts, and in particular polymer compounds, is widely undertaken. There are various compounds used such as, for example: (co)polymers of diallyl ammonium salt derivatives (see, for example, JP-A Nos. 60-83882, 64-75281 and 59-20696); copolymers of allyl amine salts ((see, for example, JP-A Nos. 61-61887 and 61-72581); ammonium salt containing (meta) acrylate and (meta)acrylamide based (co)polymers; vinyl (co) polymers such as vinyl benzyl ammonium salt (co)polymers (see, for example, JP-A Nos. 6-340163, 4-288283, 7-242055, 9-300810, 8-318672, 10-272830, 63-115780), modified polyvinyl alcohols (see, for example, JP-A Nos. 6-234268 and 11-277888), polyamidine (see, for example, JP-A Nos. 11-58934 and 11-28860). These compounds are used with the aim of fixing the dyes used, and stopping the development of bleeding with the passing of time.

However, since these compounds are fundamentally water soluble polymers, and they cannot completely fix water-soluble dyes. So, in particular at high humidity, improvements in the suppression of the development of bleeding with the passing of time are still not sufficient. Also, when stored in clear plastic file inserts directly after printing, moisture in the ink and small amounts of high boiling point solvents used in inks (glycerin and diethylene glycol derivatives) remain. Because of this bleeding still occurs with the passing of time.

In the same way basic latexes, which include tertiary amine groups and quaternary ammonium salts and are water-insoluble, are known (see, for example, JP-A Nos. 57-36692, 11-180034, 11-20302, and 8-244336). Efforts are made to improve the water resistance, by using the hydrophobic nature of these latexes.

However, in order to give sufficient water resistance, these compounds must be added in large amounts. As a result of this the problems of deterioration in image light-fastness and reduction of pigment compatibility are induced. Also, in order to form the hydrophobic monomers, with tertiary amine group and quaternary ammonium salts, into latexes cross-linking monomers are used (in other words, for the polymers, polymerizable monomers with two or functional groups). Because of this, penetration of the water soluble ink into the pigment fine particles becomes difficult, and the ink receivability cannot be said to be sufficient. Also, when an ink receiving layer of a porous film is used, in order to add fine particle compounds pores in the porous layer are blocked, and this harms the ink absorption ability.

Further more, even using the above method, if stored in clear plastic file inserts directly after printing, or for a long time, particularly under conditions of high humidity, there is the problem that bleeding develops in images with the passing of time.

Also disclosed is, rather than latexes, the use of hydrophobic vinyl benzyl ammonium salt-based cationic polymers which are water-insoluble but solvent soluble (see, for example, JP-A No. 2000-239014). However, even when these are used, whilst there is great improvement in the suppression of bleeding which develops with the passing of time, the problem of a reduction in light-fastness is induced.

Efforts to both prevent bleeding which develops with the passage of time and to suppress a reduction in the light-fastness have been carried out, for example the use of a cationic monomer containing a cationic moiety, based on (meta) acrylate and/or (meta)acrylamide, and a cationic moiety, based on vinylbenzyl ammonium salt. However, the improvement effected on the development of bleeding with the passage of time is not sufficient (see, for example, 11-348409).

Also recorded as a possible way to improve the development of bleeding with the passage of time, is the use of a (co) polymer of a water soluble polymer (containing a cationic proportion of 40 mol % or more) based on vinyl benzyl ammonium salts (see, for example, International Publication (WO) No. 99/64248 pamphlet). However, whilst the development of bleeding with the passing of time is improved, a reduction in the ink absorption ability and reduction of image density are induced. Also, when silica is used as fine particles, the dispersing ability of the fine particles may be deteriorated.

In such a manner, an ink jet recording medium which provides good ink absorption ability, can form a high definition image with high density, which is superior in image storability (light-fastness, ozone resistance), and, particularly when stored for a long period of time under conditions of high humidity, does not develop bleeding with the passage of time, has yet to be developed.

### SUMMARY OF THE INVENTION

The present invention has been made in view of the above circumstances and provides an inkjet recording medium which does not develop bleeding with the passing of time, even when stored for a prolonged period of time under conditions of high humidity.

In order to address the above issues the present invention has the following aspects.

(1) An inkjet recording medium comprising a support body on which is provided an ink receiving layer wherein: the ink receiving layer is formed by using a coating liquid which comprises at least one type of water-soluble multi-valent metal salt and an aqueous dispersion of a cation modified self-emulsifying polymer compound, in which the dispersion is an aqueous dispersion of a cationic urethane resin with a glass transition temperature of less than 50° C., and has an average particle size of 0.05 μm or less.

(2) The inkjet recording medium of (1), wherein the ink receiving layer further comprises at least one compound selected from the group containing polyvinyl alcohol based resins, cellulose based resins, resins with ether bonds, resins with carbamoyl groups, resins with carboxyl groups and gelatins.

(3) The inkjet recording medium of any of (1) or (2), wherein the ink receiving layer further comprises fine particles.

(4) The inkjet recording medium of (3), wherein the fine particles are fine particles selected from the group containing organic fine particles, silica fine particles, colloidal silica fine particles, alumina fine particles and pseudo boehmite hydrate aluminum fine particles.

(5) The inkjet recording medium of any of (1) to (4), wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

Since the inkjet recording medium of the invention includes in the ink receiving layer a cationic modified self-emulsifying polymer, there is an improvement in the suppressing the development of bleeding with the passing of time. Also, because in the ink receiving layer additionally is included a water soluble multi-valent metal salt, it is applicable to address the bleeding of a wider range of dyes.

Also, by using, as the cationic modified self-emulsifying polymer, a cationic urethane resin, the strength of the ink receiving layer membrane can be increased, and it is possible to obtain a coated surface condition where minute cracks are stopped. This, effect can be further enhanced by the inclusion of the water soluble multi-valent salt and in particular poly-aluminum chloride and/or zirconyl acetate.

Further still, when the glass transition point of the cationic modified urethane resin is less than 50° C., as well as the above improvement in the surface condition, positive curl under conditions of low temperature/low humidity can be avoided. Thereby, there is no occurrence of the problem of poor feedability in a printer, and the value of the product is not reduced. Also, there can be an improvement against damage to the surface, such as cracks.

### DETAILED DESCRIPTION OF THE INVENTION

The main embodiments and manufacture of the invention will now be described in detail.

The inkjet recording medium of the invention comprises a support body on which is provided an ink receiving layer. The ink receiving layer is formed by using a coating liquid which comprises at least one type of water soluble multi-valent metal salt and an aqueous dispersion of a cation modified self-emulsifying polymer compound. The aqueous dispersion has an average particle size of 0.05 μm or less. Further, depending on the application and the requirements, the inkjet recording medium of the invention may also include a water soluble resin and cross-linking agent, fine particles, mordant, and other additives. Also, another layer can also be provided on the support body. In the invention it is preferable that the ink receiving layer is formed on the support body by a wet-on-wet method.

Below the details of the main configurations and manufacturing of the invention will be explained.

(Aqueous Dispersion of Cation Modified Self-Emulsifying Polymer Compound)

The ink receiving layer of the inkjet recording medium of the invention is formed by using a coating liquid which includes at least a “cation modified self-emulsifying polymer compound”. This “cation modified self-emulsifying polymer compound” means a polymer compound from which can be obtained naturally a stable emulsion dispersion in an aqueous medium without the addition of emulsifier or surfactant, or if they are used by only adding a trace amount thereof. Qualitatively, the above “cation modified self-emulsifying polymer compound” represents polymer substances which have a stable emulsifying ability of a concentration of 0.5 mass % or greater in an aqueous dispersal medium at 25° C. This concentration is preferably 1 mass % or greater, and particularly preferably 3 mass % or greater.

More specific examples of the above “cation modified self-emulsifying polymer compound” of the invention are, for example, poly-addition or polycondensation based polymer compounds including cationic groups of primary, secondary or tertiary amine groups, or quaternary ammonium groups.

For the above polymers, vinyl polymerization based polymers can be used, such as polymers obtained by the polymerization of the following vinyl monomers. Examples include: acrylic acid esters and meta acrylic acid esters (as substituents for the ester group are alkyl and allyl groups, for example the following groups can be used, methyl, ethyl, n-propyl, isopropyl, n-butyl, sec-butyl, tert-butyl, hexyl, 2-ethylhexyl, tert-octyl, 2-chloroethyl, cyanoethyl, 2-acetoxyethyl, tetrahydrofurfuryl, 5-hydroxypentyl, cyclohexyl, benzyl, hydroxyethyl, 3-methoxybutyl, 2-(2-methoxyetoxy)ethyl, 2,2,2-tetrafuroroethyl, 1H, 1H, 2H, 2H-perfluorodecyl, phenyl, 2,4,4-tetramethyl phenyl, 4-chlorophenyl); vinyl esters, specifically aliphatic carboxylic acid vinyl esters which may have substituents (for example, vinyl acetate, vinyl propionate, vinylbutyrate, vinyl isobutyrate, vinylcaproate, vinylchloroacetate), aromatic carboxylic acid esters which may have substituents (for example benzoic acid vinyl, 4-methyl benzoic acid vinyl, salicylic acid); acrylic amides specifically acrylic amides, N-mono substituted acrylic amides, N-di substituted acrylic amides (for substituents there are substitutable groups such as alkyl, aryl, and silyl—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups); methacrylic amides, specifically methacrylic amides, N-mono substituted methacrylic amides, N-di substituted methacrylic amides (for substituents there are substitutable groups such as alkyl, aryl, and silyl—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups); olefins (for example ethylene, propylene, 1-pentene, vinyl chloride, vinylidene chloride, isoprene, chloroprene, butadiene), styrenes (for example styrene, methylstyrene, isopropylstyrene, methoxystyrene, acetoxystyrene, and chlorostyrene), vinyl ethers (for example methyl vinyl ether, butyl vinyl ether, hexyl vinyl ether, and methoxyethyl vinyl ether).

As the other vinyl monomer, examples include listed crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, dipheyl-2-methacryloyloxyethyl phosphate, dibutyl-2-acryloyloxyethyl phosphate, dioctyl-2-methacryloyloxyethyl phosphate and the like.

As the above-mentioned monomer having a cationic group, there are, for example, monomers having a tertiary amino group, such as dialkylaminoethyl methacrylates, dialkylaminoethyl acrylates and the like.

As polyurethanes applicable to the cationic-group-containing polymer, there are, for example, polyurethanes synthesized by the addition polymerization reaction of various combinations of the diol compounds with the diisocyanate compounds listed below.

Examples of the above-mentioned diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, 4000), polypropylene glycols (average molecular weight=200, 400, 1000), polyester polyols, 4,4′-dihydroxy-diphenyl-2,2-propane, 4,4′-dihydroxyphenylsulfonic acid, and the like.

As the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylene bis(4-cyclohexyl isocyanate), and the like.

As the cationic group contained in the cationic group-containing polyurethane, there are cationic groups such as primary, secondary and tertiary amines and quaternary ammonium salts. In the self-emulsifying polymer of the invention, it is preferable to use a urethane resin with cationic groups such as tertiary amines or quaternary ammonium salts. The cationic group-containing polyurethanes can be obtained, for example, by introducing cationic groups such as the above diols at the time of synthesizing the polyurethane. Also, in the case of quaternary ammonium salts, polyurethanes containing tertiary amino groups can be quaternized with a quaternizing agent.

The diol compounds and diisocyanate compounds usable for synthesizing the polyurethane may be used each alone, or may be used in combinations of two or more in various proportions decided depending on the purpose (for example, control of the polymer glass transition temperature (Tg), improving solubility, providing compatibility with a binder, and improving stability of a dispersion).

As the polyester applicable to the cationic-group-containing polymer, there are, for example, polyesters synthesized by polycondensation reactions of various combinations of the diol compounds with the dicarboxylic acid compounds listed below.

As the above-mentioned dicarboxylic acid compounds, there are listed oxalic acid, malonic acid, succinic acid, glutaric acid, dimethylmaleic acid, adipic acid, pimelic acid, α, α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethyleneterephthalate)dicarboxylic acid, 1,2-cyclohexanedicarboxylic acid, 1,4-cyclohexanedicarboxylic acid, ω-poly(ethyleneoxide)dicarboxylic acid, p-xylylenedicarboxylic acid and the like.

The above-mentioned dicarboxylic acid compound may, when polycondensed with a diol compound, be used in the form of an alkyl ester (for example, dimethyl ester) of a dicarboxylic acid or an acid chloride of a dicarboxylic acid, or be used in the form of an acid anhydride such as maleic anhydride, succinic anhydride and phthalic anhydride.

As the diol compound, the same compounds as the diols exemplified for the above-mentioned polyurethane can be used.

The cationic group-containing polyester can be obtained by synthesis using a dicarboxylic acid compound having a cationic group such as primary, secondary and tertiary amines and quaternary ammonium salts.

The above-mentioned diol compounds, dicarboxylic acids and hydroxycarboxylate ester compounds used in synthesis of the polyester may each be used alone, or may be used in combinations of two or more in selected proportions depending on the purpose (for example, control of the polymer glass transition temperature (Tg), solubility, compatibility with dyes, and stability of dispersion).

The content of the cationic group in the cationic-group-containing polymer is preferably from 0.1 to 5 mmol/g, and more preferably from 0.2 to 3 mmol/g. When the content of the cationic group is too low, the polymer dispersion stability decreases, and when too high, binder compatibility decreases.

The above self-emulsifying polymers including cationic group(s) preferable are polymers including cations of tertiary amine or quaternary ammonium salts, and the particularly preferable are urethane resins like the ones above.

When the above self-emulsifying polymers are used an ink receiving layer of the invention, particularly important is the glass transition temperature thereof. After forming an image by inkjet recording, in order to suppress the occurrence of bleeding with the passage of time, the glass transition temperature of the above self-emulsifying polymer is preferably below 50° C. Further, the self-emulsifying polymer glass transition temperature is more preferably 30° C. or below, and even particularly preferable is a glass transition temperature of 15° C. or below. If the glass transition temperature is 50° C. or above then the dimensional stability (curl) worsens. Here, there is no particular lower limit to the glass transition temperature but, for normal applications it is of the order of −30° C., and if it is lower than this then when preparing the aqueous dispersant the manufacturability can be reduced.

For the mass average of the molecular weight of the self-dispersing polymer used in the invention, usually this is preferably 1000 to 200,000, and 2000 to 50,000 is more preferable. If the molecular weight is less than 100 then there is a tendency that obtaining a stable aqueous dispersant becomes difficult. If the molecular weight exceeds 200,000 then the solubility decreases, the viscosity of the liquid increases and the controlling to a small average particle size the particles of aqueous dispersant tends to become difficult, particularly controlling to 0.05 μm or less.

Regarding the amount of the above self-emulsifying polymer to be included in the ink receiving layer of the invention, this is preferably in the range of 0.1 to 20 mass % relative to the total solid contents in the structure of the ink receiving layer, 0.3 to 20 mass % is more preferable and 0.5 to 15 mass % is most favorable. If the above amount included is less than 0.1 mass % then there is insufficient improvement in the bleeding which occurs with the passage of time. On the other hand, if the amount included is over 30 mass % then the proportion of fine particles or binder components gets smaller, and the ink absorption ability on a high quality image recording paper tends to be reduced.

Next, the preparation method of the self-emulsifying polymer of the invention will be explained.

The above self-emulsifying polymer is mixed into an aqueous solvent medium, and as required additives are mixed in, and by fragmenting the mixture liquid using a dispersal apparatus, an aqueous dispersion with an average particle size of 0.05 μm or below can be obtained. In order to obtain the aqueous dispersion, various known dispersal apparatuses such as the following can be used: high speed rotary dispersal apparatus, a medium agitation type dispersal apparatus (such as a ball mill, sand mill, bead mill), ultra-sound dispersal apparatus, colloid mill dispersal apparatus, high pressure dispersal apparatus. However, from the perspective of efficiently dispersing the clump-like fine particles, a medium agitation type dispersal apparatus, colloid mill dispersal apparatus or high pressure dispersal apparatus are preferable.

As a high pressure dispersal apparatus (homogenizer) there is the construction described in U.S. Pat. No. 4,533,254, JP-A No. 6-47264 and the like but commercially available apparatuses such as GAULIN HOMOGENIZER (A.P.V Gaulin Inc.), MICROFLUIDIZER (Microfluidex Inc.), ALTIMIZER (Sugino Machine K.K.) can be used. Recently, a high pressure homogenizer equipped with a mechanism to form fine particles in an ultrahigh pressure jet flow as described in U.S. Pat. No. 5,720,551 is particularly effective for emulsifying dispersion of the present invention. DeBEE2000 (Bee International Ltd.) is as an example of an emulsifying apparatus using an ultrahigh pressure jet flow.

For the aqueous medium used in the above dispersing process the following can be used water, organic solvent media, or mixture media thereof. Useable organic solvent media for the dispersing are: alcohols such as methanol, ethanol, n-propanol, i-propanol, and methoxy propanol; ketones such as acetone, methyl ethyl ketone; tetrahydrofuran, acetonitrile, ethyl acetate, toluene.

With the above self-emulsifying polymer, while with the polymer itself a stable emulsion dispersion can be obtained naturally, in order to speed up the emulsifying dispersion and to make it more stable, a small amount of dispersant (surfactant) can be used. For this purpose various surfactants can be used. Preferable examples are anionic surfactants such as fatty acid salts, alkylsulfate ester salts, alkylbenzenesulfonate salts, alkylnaphthalenesulfonate salts, dialkylsulfosuccinate salts, alkylphosphate ester salts, naphthalenesulfonic acid formalin condensates, polyoxyethylene alkylsulfate ester salts and the like. And nonionic surfactants such as polyoxyethylene alkyl ethers, polyoxyethylene alkylaryl ether, polyoxyethylene fatty acid esters, sorbitan fatty acid esters, polyoxyethylene sorbitan fatty acid esters, polyoxyethylene alkyl amines, glycerine fatty acid esters, oxyethylene oxypropylene block copolymers and the like. Further, SURFYNOLS (Air Products & Chemicals), an acetylene-based polyoxyethylene oxide surfactant is also preferably used. Furthermore, amine oxide type ampholytic surfactants such as N,N-dimethyl-N-alkylamine oxide, and the like are also preferable. Further, surfactants listed in JP-A No. 59-157,636, pp. (37) to (38) and Research Disclosure No. 308119 (1989) can be used.

For obtaining stability directly after emulsification, a water-soluble polymer can also be added together with the above-mentioned surfactant. As the water-soluble polymer, polyvinyl alcohols, polyvinylpyrrolidone, polyethylene oxide, polyacrylic acid, polyacrylamide, and copolymers thereof are preferably used. Further, it is also preferable to use naturally occurring water-soluble polymers such as polysaccharides, casein, gelatin and the like.

In the above emulsifying method, when dispersing the above self-emulsifying polymer of the invention in an aqueous medium, particularly important is control of the particle size. When forming an image using an inkjet process, in order to raise the color purity, it is necessary to make the average size of the particles of the self-emulsifying polymer of the above aqueous dispersion small. Specifically, in the ink receiving layer of the invention, it is necessary to make the volume average particle size 0.05 μm or less, and preferably 0.04 μm or less, and 0.03 μm or less if even more preferable.

(Fine Particles)

Generally, the ink receiving layer according to the present invention preferably contains fine particles.

The above fine particles are preferably inorganic fine particles. Examples of inorganic fine particles include fine particles of silica fine particles, colloidal silica, titanium dioxide, barium sulfate, calcium silicate, zeolite, kaolinite, halloysite, mica, talc, calcium carbonate, magnesium carbonate, calcium sulfate, boehmite, pseudoboehmite. Among these fine particles, silica fine particles are preferable.

The silica in the above has an extremely high specific surface area, and provides the layer with a higher ink absorption and retention capacity. In addition, the silica has a low refractive index, and thus if dispersed to a suitable particle diameter, provides the ink receiving layer with better transparency, and higher color density and favorable coloring is obtainable. The transparency of ink receiving layer is important from the viewpoint of obtaining a high color density and favorable coloring glossiness not only for applications wherein the transparency is required such as OHP sheets and the like, but also for applications as recording sheets such as photographic glossy papers and the like.

The average primary particles diameter of the inorganic pigment fine particles is preferably 20 nm or less, more preferably 15 nm or less, and particularly preferably 10 nm or less. When the average primary particle size of the particles is 20 nm, the ink-absorbing property can be effectively improved and at the same time, the glossiness of the surface of the ink receiving layer can be enhanced.

In particular with silica fine particles, since the surface has silanol groups, there is easy adhesion between the particles through the hydrogen bonding of the silanol groups, and there is an adhesion effect between the particles through the silanol groups and the water soluble resin. Hence, if the average primary size of the particles is 20 nm or below, then the porosity ratio of the ink receiving layer is high, and a structure with high transparency can be formed, and the ink absorption ability characteristics can be effectively raised.

Silica fine particles are commonly classified roughly into wet method particles and dry method (gas phase process) particles according to the method of manufacture. By the wet method, silica fine particles are mainly produced by generating an activated silica by acid decomposition of a silicate, polymerizing to a proper degree the activated silica, and coagulating the resulting polymeric silica to give a hydrated silica. Alternatively by the gas phase process, vapor-phase process silica (anhydrous silica) particles are mainly produced by high-temperature gas-phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” means an anhydrous silica fine particles produced by a gas phase process.

The vapor-phase process silica is different in the density of silanol groups on the surface and the presence of voids therein and exhibits different properties from hydrated silica. The vapor-phase process silica is suitable for forming a three-dimensional structure having a higher void percentage. The reason is not clearly understood. In the case of hydrated silica fine particles have a higher density of 5 to 8 silanol groups/nm² on their surface. Thus the silica fine particles tend to coagulate densely. While the vapor phase process silica particles have a lower density of 2 to 3 silanol groups/nm² on their surface. Therefore, vapor-phase process silica seems to cause more scarce, softer coagulations (flocculates), consequently leading to a structure having a higher void percentage.

In the present invention, the vapor phase silica (anhydrous silica) obtained by the dry method is preferable, with the surface of the silica fine particles having a density of 2 to 3 silanol groups/nm².

—Water-Soluble Resin—

It is preferable that the ink receiving layer of the invention further included a water soluble resin.

Examples of the water-soluble resins used for the ink receiving layer include polyvinyl alcohol resins having a hydroxy group as a hydrophilic constitutional unit polyvinyl alcohol (PVA), cation-modified polyvinyl alcohol, anion-modified polyvinyl alcohol, silanol-modified polyvinyl alcohol, or polyvinylacetal; cellulosic resins [methylcellulose (MC), ethylcellulose (EC), hydroxyethylcellulose (HEC), carboxymethylcellulose (CMC), etc.]; chitins; chitosans; starch; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), etc.]; and the like. In addition, resins having a carboxyl group as the dissociative group, such as polyacrylate salts, maleic acid resins, and alginate salts; gelatins, and the like, are also included. Among the resins, polyvinyl alcohols are particularly preferable.

In order to prevent reduction of layer strength or layer cracking at the time t when the layer is dried, due to too small a content of the water-soluble resin, and prevent reduction of ink absorbing ability caused by blocking of voids by resin due to too high a content of resin, the content of the water-soluble resin in the ink receiving layer is preferably 9 to 40%, more, preferably 12 to 33% by mass with respect to the total solid mass in ink receiving layer. These water-soluble resins and the fine particles described above each may be a single-component substances or a combinations of multiple components.

From the viewpoint of preventing cracking of the layer, the number average polymerization degree of the polyvinyl alcohol is preferably 1800 or more, more preferably 2000 or more. From the view point of transparency of the layer, when water soluble resin is used in combination with the silica fine particles, the kind of water soluble resin is important. For combination with anhydrous silica, polyvinyl alcohol resins are preferable as the water-soluble resin. Among them, polyvinyl alcohol resins having a saponification degree of 70 to 99% are preferable.

In addition, the polyvinyl alcohol resin may be used together with other water-soluble resins. When another water-soluble resin and a polyvinyl alcohol resin are used in combination, the amount of polyvinyl alcohol resin is preferably 50% or more, more preferably 70% by mass or more with respect to total water-soluble resins.

Examples of the above polyvinyl alcohol include not only polyvinyl alcohol (PVA) but also cation-modified polyvinyl alcohol, anion-modified polyvinyl alcohol, silanol-modified polyvinyl alcohol, and other polyvinyl alcohol derivatives. It is possible to use one kind of polyvinyl alcohol on its own or combinations of two or more kinds of polyvinyl alcohols.

The above polyvinyl alcohol resins contain a hydroxyl group as a structural unit. Hydrogen bonding between the hydroxyl groups and the surface silanol groups on silica fine particles allows the silica fine particles to form a three-dimensional network structure having secondary particles as the network chain units. This three-dimensional network structure thus constructed seems to be the cause of easier development of an ink receiving layer having a porous structure having a higher void percentage.

In ink jet recording, the ink receiving layer having a porous structure obtained in this manner absorbs inks rapidly due to the capillary phenomenon, and provides printed dots superior in circularity without ink bleeding.

<Ratio of the Fine Particles to the Water-Soluble Resin Contained>

The ratio (PB ratio:x/y, inorganic pigment fine particles to water soluble resin 1 parts by weight) of the weight of fine particles included (preferably silica fine particles; x) to the weight of water-soluble resin (y) has a great influence on the structure and strength of the ink receiving layer. A larger weight ratio (PB ratio) tends to result in increase in void percentage, pore volume, and surface area (per unit weight).

Specifically the PB ratio (x/y) for the ink receiving layer is preferably 1.5 to 10, from the viewpoints of suppressing the decrease in layer strength and prevention of cracking thereof when drying which may be caused due to an excessively high PB value, and preventing a decrease in void percentage and thus in ink absorptive property due to an larger amount of voids blocked more easily due to an excessively low PB ratio.

When conveyed in paper-conveying systems of ink jet printers, a stress may be applied to the ink jet recording medium. Accordingly, the ink receiving layer should have sufficiently high layer strength. Also from the viewpoints of preventing cracking, peeling, or the like of the ink receiving layer when the ink jet recording medium are cut into sheets, the ink receiving layer should have sufficiently high layer strength. Considering the above, the PB ratio is preferably 5 or less. On the other hand, from the viewpoint of ensuring the superior ink absorptive property in ink jet printers, the ratio is more preferably 2 or more.

For example, when a coating liquid, containing vapor-phase process silica fine particles, having an average primary particle diameter of 20 nm or less, and a water-soluble resin homogeneously dispersed in an aqueous solution at a PB ratio (x/y) of between 2/1 and 5/1, is applied and dried on a support, a three-dimensional network structure having the secondary particles of silica fine particles as the network chains is formed. Such a coating liquid easily provides a translucent porous layer having an average void diameter of 30 nm or less, a void percentage of 50 to 80%, a void specific volume of 0.5 ml/g or more, and a specific surface area of 100 m²/g or more.

—Cross-Linking Agent—

With respect to the ink receiving layer according to the invention, it is preferable that the layer containing fine particles, a water-soluble resin, and the like, contains additionally a cross-linking agent that allows cross-linking of the water-soluble resin, and thus is a porous layer hardened by the cross-linking reaction between the cross-linking agent and the water-soluble resin.

The above crosslinking agent may be selected appropriately in relation to the water-soluble resin contained in the ink receiving layer, but boron compounds are preferable, as they allow faster crosslinking reaction. Examples of the boron compounds include borax, borate salts [e.g., orthoborate salts, InBO₃, ScBO₃, YBO₃, LaBO₃, Mg₃(BO₃)₂, and Co₃(BO₃)₂], diborate salts [e.g., Mg₂B₂O₅, and Co₂B₂O₅], metaborate salts [e.g., LiBO₂, Ca(BO₂)₂, NaBO₂, and KBO₂], tetraborate salts [e.g., Na₂B₄O₇.10H₂O], pentaborate salts [e.g., KB₅O₈.4H₂O, Ca₂B₆O₁₁.7H₂O, and CsB₅O₅], and the like. Among them, borax, boric acid and borates are preferable since they are able to promptly cause a cross-linking reaction. Particularly, boric acid is preferable, and the combination of polyvinyl alcohol and boric acid is most preferred.

In the invention, the above cross-linking agent is preferably included to an amount of 0.05 to 0.50 parts by weight relative to 1 part by weight of the water soluble resin. More preferable is an inclusion amount of 0.08 to 0.30 parts by weight. If the amount of inclusion of the cross-linking agent is within the above ranges then the water soluble resin can be effectively be cross-linked and development of cracks and the like can be prevented.

When gelatin and the like are used as a water-soluble resin in the invention, other compounds than the boron compounds, as described below, can be used for the cross-linking agent of the water-soluble resin.

Examples of such cross-linking agents include: aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylenebis(vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resins; isocyanate compounds such as 1,6-hexamethylenediisocyanate; aciridine compounds such as those described in U.S. Pat. Nos. 3,017,280 and 2,983,611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecular compounds or polymers containing at least two oxazoline groups. These cross-linking agent may be used alone, or in combinations of two or more thereof.

In the invention, the cross-linking agent can be supplied in a number of ways, such as when forming the ink receiving layer, the above cross-linking agents can be added to the ink receiving layer coating liquid and/or a coating liquid which is used for forming a layer adjacent and contacting the ink receiving layer. Or a coating liquid which includes the cross-linking agent can be applied in advance onto the support body and the ink receiving layer coating liquid can be coated. Or, a solution of the cross-linking agent can be over-coated onto a coating of an ink receiving layer coating liquid after it has dried. From the perspective of manufacturing efficiency, it is preferable that the cross-linking agent is added to the ink receiving layer coating liquid or a coating liquid for forming an adjacent contacting layer, and the cross-linking agent is supplied at the same time as forming the ink receiving layer. In particular, from the perspective of raising the print image density and glossiness of images, it is preferable to include the cross-linking agent in the coating liquid for the ink receiving layer. It is preferable that the concentration of the cross-linking agent in the ink receiving liquid coating layer is between 0.05 and 10% by mass, and more preferable between 0.1 and 7% by mass.

The cross-linking agent, for example the boron compound, is preferably added as follows. Here an example will be described where a boron compound is used. When the ink receiving layer is formed through curing by causing cross-linking of the coating layer by applying an coating solution (coating solution 1) for the ink receiving layer, the layer is cured by cross-linking by applying a basic solution (coating solution 2) having a pH value of 7.1 or more on the coating layer, either (1) at the same time for forming the coating layer by applying coating solution 1; or (2) during the drying step of the coating layer formed by applying coating solution 1 and also before the coating layer exhibits a decrease in the rate of drying. The boron compound acting as the cross-linking agent may be contained in either coating solution 1 or coating solution 2, or alternatively may be contained in both the coating solution 1 and coating solution 2.

(Mordant)

In the invention, in order to raise the water resistance and resistance to the occurrence of bleeding with the passage in time of formed images, it is preferable that a mordant is added to an ink receiving layer. For the mordant can be used an inorganic mordant such as a cationic polymer (cationic mordant), or a inorganic mordant such as a water soluble metallic compound. Among these water soluble multi-valent metal salts are preferable.

For the water soluble multivalent metal salt compounds of the invention water soluble salts of the following metals can be used: calcium, barium, manganese, copper, cobalt, nickel, aluminum, iron, zinc, zirconium, chromium, magnesium, tungsten, molybdenum.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper II chloride, copper II ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminum sulfite, aluminum thiosulfate, polychlorinated aluminum, aluminium nitrate nonahydrate, aluminium chloride hexahydrate, iron I bromide, iron I chloride, iron II chloride, iron II sulfate, iron II sulfate, zinc bromide, zinc chloride, zinc nitrate hexahydrate, zinc sulfate, zirconyl acetate, zirconium chloride, zirconium oxychloride octahydrate, zirconium hydroxychoride, chromium acetate, chromium sulfate, manganese sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, and the like.

For the above soluble multivalent metal salt compounds it is preferable to select one or more from soluble aluminum compounds, zirconium compounds or titanium compounds. For the above aluminum compounds, for example, inorganic salts such as aluminum chloride, or hydrates thereof, aluminum sulfate or hydrates thereof, and aluminum alum are known. Further more, there are inorganic based aluminum cationic polymers such as basic poly hydroxylated aluminum compounds. Basic poly hydroxylated aluminum compounds are preferable.

The above basic poly hydroxylated aluminum compounds, are water soluble polyhydroxylated aluminum compounds stably including multi-nucleated condensate ions, such as [Al₆ (OH)₁₅]³⁺, [Al₈(OH)₂₀]⁴⁺, [Al₁₃(OH)₃₄]⁵⁺, [Al₂₁(OH)₆₀]³⁺, of basic polymers basic polymers. They have as their main components the compounds show in the formula 1, 2 and 3 below.
[Al₂(OH)ₙ Cl₆₋ₙ]ₘ Formula 1
[Al(OH)₃]ₙ AlCl₃ Formula 2
Alₙ(OH)ₘ Cl₍₃ₙ₋ₘ₎ 0<m<3n Formula 3

These compounds can be easily obtained and are placed on the market by Taki Chemical Co. Ltd. as polychlorinated aluminum (PAC) as water treatment agents, by Asada Kagaku Co. Ltd. as polyhydrated aluminium (Paho), also by Rikengreen Co. Ltd., and other manufacturers for the same purpose. In the invention is is suitable to use the commercially available products directly, but since there are materials which have inappropriately low pH values, in these cases it is possible to use by suitably adjusting the pH.

For the zirconium compounds of the invention there are no particularly limitations and various compounds can be used. However, examples which can be given are compounds of zirconyl acetate, zirconium choride, zirconium oxychloride, zirconium hydroxychloride, zirconyl nitrate, basic zirconium carbonate, zirconium hydroxide, zirconium ammonium carbonate, zirconium potassium carbonate, zirconium sulphate, zirconium fluoride. Zirconyl acetate is particularly preferable.

For the above titanium compounds, there are no particular limitations and various compounds can be used, for example titanium chloride, and titanium sulfate.

Since the pH of some of these compounds is inappropriately low, the pH can be adjusted to an appropriate value. In the invention, as a guide, the solubility in water at normal temperature and pressure should be greater than 1%, relative to the water by mass.

In the invention the amount of the above water soluble multi-valent metal salt compounds included in the ink receiving layer is preferably 0.1 to 10% by mass relative to the fine particles, and more preferably 1 to 5% by mass.

The above water soluble multi-valent metal salt compounds can be used alone but they are preferably used in combinations of two or more.

By having the above mordants at least in the upper portion of the ink receiving layer, due to the interaction of the anionic dyes used as the coloring materials in the inkjet liquid inks, the coloring material can be stabilized and the water resistance and tendency to bleed after a lapse of time can be improved.

For the above cationic mordants, polymers mordants with cationic groups of primary, secondary or tertiary amino groups, or quaternary ammonium salt groups are well suited but non-polymer mordants which are cationic also can be used.

For the above polymer mordants, preferable are single polymers of monomers with primary, secondary or tertiary amino groups or salts thereof, or quaternary ammonium salt groups (referred to below as mordant monomers), and copolymers or condensation polymers of the mordant monomers with other monomers (referred to below as non-mordant monomers). Also, these polymer mordants can be used in the form of either water soluble polymers, or water dispersible latex particles.

Examples of the above mordant monomer include trimethyl-p-vinylbenzylammonium chloride, trimethyl-m-vinylbenzylammonium chloride, triethyl-p-vinylbenzyl ammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinyl benzyl ammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzyl ammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl) ethylammonium chloride, N,N-diethyl-N-methyl- N-2-(4-vinylphenyl)ethylammonium acetate; quaternary compounds obtained by reacting methyl chlorides, ethyl chlorides, methyl bromides, ethyl bromides, methyl iodides, or ethyl iodides of N,N-dimethylaminoethyl (meth)acrylate, N,N-diethylaminoethyl (meth)acrylate, N,N-dimethylaminopropyl (meth) acrylate, N,N-diethylaminopropyl (meth)acrylate, N,N-dimethylaminoethyl (meth) acrylamide, N,N-diethylaminoethyl (meth)acrylamide, N,N-dimethylaminopropyl (meth) acrylamide, or N,N-diethylaminopropyl (meth)acrylamide; and sulfonates, alkyl sulfonates, acetates, or alkyl carboxylates derived from the quaternary compounds by replacement of the anion.

Specific examples of such compounds include monomethyldiallylammonium chloride, trimethyl-2-(methacryloyloxy)ethylammonium chloride, triethyl-2-(methacryloyloxy) ethylammonium chloride, trimethyl-2-(acryloyloxy)ethylammonium chloride, triethyl-2-(acryloyloxy)ethylammonium chloride, trimethyl-3-(methacryloyloxy) propylammonium chloride, triethyl-3-(methacryloyloxy)propylammonium chloride, trimethyl-2-(methacryloylamino)ethylammonium chloride, triethyl-2-(methacryloylamino) ethylammonium chloride, trimethyl-2-(acryloylamino) ethylammonium chloride, triethyl-2-(acryloylamino)ethylammonium chloride, trimethyl-3-(methacryloylamino) propylammonium chloride, triethyl-3-(methacryloylamino)propylammonium chloride, trimethyl-3-(acryloylamino) propylammonium chloride, triethyl-3-(acryloylamino) propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy) ethyl ammonium bromide, trimethyl-3-(acryloylamino)propylammonium bromide, trimethyl-2-(methacryloyloxy)ethylammonium sulfonate, and trimethyl-3-(acryloylamino) propylammonium acetate.

Examples of other copolymerizable monomers include N-vinylimidazole and N-vinyl-2-methylimidazole.

Further, allylamine, diallyamine, and derivatives and salts thereof may also be used. Examples of these compounds include allylamine, allylamine hydrochloride, allylamine acetate, allylamine sulfate, diallyamine, diallyamine hydrochloride, diallyamine acetate, diallyamine sulfate, diallylmethylamine and the salts thereof (e.g., hydrochloride, acetate, and sulfate salts, and the like), diallylethylamine and the salts thereof (e.g., hydrochloride, acetate, and sulfate salts, and the like), diallyldimethylammonium salts (counter anions thereof including chloride, acetate, and sulfate ions), and the like. These allylamine and diallyamine derivatives are less polymerizable in the amine form, and thus are commonly polymerized in the salt form and desalted thereafter if necessary. Further, polymerization units of N-vinylacetamide and N-vinylformamide can be used, to give vinylamine units by hydrolyzation after polymerization, or salts thereof can be used.

The term “a non-mordant monomer” refers to a monomer that does not have a basic or cationic moiety, such as a primary, secondary or tertiary amino group, a salt thereof, or a quaternary ammonium salt group, and exhibits no or substantially little interaction with dye in inkjet ink.

Examples of non-mordant monomers include alkyl ester (meth)acrylates; cycloalkyl ester (meth)acrylates such as cyclohexyl (meth)acrylate; aryl ester (meth)acrylates such as phenyl (meth)acrylate; aralkyl ester(meth)acrylates such as benzyl (meth)acrylate; aromatic vinyl compounds such as styrene, vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

The above alkyl ester (meth)acrylates preferably have 1 to 18 carbon atoms in the alkyl moiety. Examples of such alkyl ester (meth)acrylates include methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, hexyl (meth)acrylate, octyl (meth)acrylate, 2-ethylhexyl (meth)acrylate, lauryl (meth)acrylate, and stearyl (meth)acrylate.

Particularly preferred are methyl acrylate, ethyl acrylate, methyl methacrylate, ethyl methacrylate, and hydroxyethyl methacrylate.

One kind of non-mordant monomer may be used alone or two or more kinds of non-mordant monomers may be used in combination.

Preferred examples of the polymeric mordant also include poly diallyldimethyl ammonium chloride, poly methacryloyloxyethyl-β-hydroxyethyldimethylammonium chloride, poly ethyleneimine, polyallylamine and modified derivatives thereof, polyallylamine hydrochloride, polyamide-polyamine resins, cationized starch, dicyandiamide formaldehyde condensates, dimethyl-2-hydroxypropylammonium salt polymers, polyamidine, polyvinylamine, and an acrylic cationic emulsion of an acryl silicone latex described in JP-A Nos. 10264511, 2000-43409, 2000-343811 and 2002-120452 (“AQUABRID ASi-781, ASi784, ASi-578 and ASi-903 (Trade Name) manufactured by Daicel Chem. Ind. Ltd.).

Regarding the molecular weights of the above mordants, the weight average molecular weight is preferably 2000 to 300,000. If the molecular weight is in this range then the water resistance and the tendency to develop bleeding with the lapse of time can be further improved.

Other Components

In addition, the ink receiving layer is constructed to contain the following components if necessary.

To restrain the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivative and benzotriazolyl phenol derivatives. Specific examples include α-cyano-phenylc innamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenols in which at least one or more of the second place and/or the sixth place is substituted by a branching alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers as described in JP-A Nos. 47-10537, 58-111942, 58-212844, 59-19945, 59-46646, 59-109055 and 63-53544, Japanese Patent Application (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

An optical brightening agent can be also used as an ultraviolet absorber, and specific examples include a coumalin based optical brightening agent. Specific examples are described in JP-B Nos. 45-4699 and 54-5324 or the like.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl) propane, 1,1-bis(4-hydroxyphenyl)-2-ethylhexane, 2-methy-4-methoxy-diphenylamine, 1-methyl-2-phenyl indole.

These anti-fading agents can be used singly or in combinations of two or more. The anti-fading agents can be dissolved in water, dispersed, emulsified, or they can be included within microcapsules. The amount of the anti-fading agents added is preferably 0.01 to 10% by mass, relative to the total ink receiving layer coating liquid.

In the invention, in order to prevent curl, it is preferable to include organic solvents with a high boiling point in the ink receiving layer.

For the above high boiling point organic solvents water soluble ones are preferable. As water soluble organic solvents with high boiling points the following alcohols are examples: ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of less than 400). Diethylene glycol monobutylether (DEGMBE) is preferable.

The amount of the above high boiling point organic solvents used in the coating liquid for the ink receiving layer is preferably 0.05 to 1% by mass, and particularly favorable is 0.1 to 0.6% by mass.

Also, for the purpose of increasing the dispersability of the inorganic pigment fine particles, each of the types of inorganic salts can have the pH adjusted with the inclusion of acids or alkalis.

Further, in order to suppress the generation of on the surface of friction charging and exfoliation charging, conductive metallic compound fine particles, and matting agents, for reducing the surface friction, can be included.

Support Body

A transparent support body made of a transparent material such as plastic, and opaque support body composed of an opaque material such as paper can be used as a support which can be used for the invention. Especially, a transparent support or an opaque support having high glossiness is preferably used to make the best use of the transparency of the ink receiving layer.

Material which is transparent and can endure radiant heat when used on OHPs and backlight displays is preferable as a material which can be used for the above transparent support. Examples of the material include polyesters such as polyethylene terephthalate (PET); polysulfone, polyphenylene oxide, polyimide, polycarbonate and polyamide. The polyesters are preferable among them, and especially, polyethylene terephthalate is preferable.

The thickness of the transparent support is not particularly limited. However, a thickness of 50 to 200 μm is preferable in view of easy of use.

An opaque support having high glossiness whose the surface on which the ink receiving layer is formed has a glossiness degree of 40% or more is preferable. The glossiness degree is a value determined according to the method described in JIS P-8142 (paper and a paperboard 75 degree method for examining specular glossiness degree).

Examples of such supports include the following supports.

Examples include paper supports having high glossiness such as art paper, coat paper, cast coat paper and baryta paper used for a support for a silver salt photography or the like; polyesters such as polyethylene terephthalate (PET), cellulose esters such as nitrocellulose, cellulose acetate and cellulose acetate butyrate, opaque high glossiness films which are constituted by incorporating white pigment or the like in plastic films such as polysulfone, polyphenylene oxide, polyimide, polycarbonate and polyamide (a surface calendar treatment may be performed); or, supports in which a coating layer made of polyolefin which either does or does not contain a white pigment is formed on the surface of a high glossiness film containing the various paper supports, transparent supports or white pigment or the like.

Also, white pigment-containing foam polyester film (for instance, a foam PET which contains the polyolefin fine particles, and contains voids formed by drawing out) is preferable. Further, a resin coated paper for silver halide salt photographic use is suitable.

The thickness of the opaque support is not particularly limited. However, a thickness of 50 to 300 μm is preferable in view of ease of handling.

One treated by corona discharge treatment, glow discharge treatment, flame treatment or ultraviolet radiation treatment or the like may be used for the surface of the support, so as to improve wetting and adhesion properties.

Next, base paper used for paper support, such as resin coated paper, will be described.

The base paper is mainly made of wood pulp, and is made by using a synthetic pulp, such as polypropylene, in addition to the wood pulp if necessary, or a synthetic fiber such as nylon or polyester. LBKP, LBSP, NBKP, NBSP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass.

A chemical pulp with few impurities (sulfate pulp and sulfite pulp) is preferably used as the pulp, and a pulp in which whiteness is improved by bleaching, is useful.

Sizing agents such as higher fatty acid and alkyl ketene dimer, white pigments such as calcium carbonate, talc and titanium oxide, paper reinforcing agents such as starch, polyacrylamide and polyvinyl alcohol, optical brightening agents, water retention agents such as polyethylene glycols, dispersing agents, and softening agents such as a quaternary ammonium can be appropriately added to the base paper.

The freeness of pulp used for papermaking is preferably 200 to 500 ml as stipulated in CSF. The sum of 24 mesh remainder portions and 42 mesh remainder portions is preferably 30 to 70% by mass as stipulated in JIS P-8207. 4 mesh remainder portion is preferably 20% by mass.

The basis weight of the base paper is preferably 30 to 250 g, and more preferably 50 to 200 g. The thickness of the base paper is preferably 40 to 250 μm. High smoothness can be imparted to the base paper by calendar treatment at the making paper step or after paper making. The density of the base paper is generally 0.7 to 1.2 g/m² (JIS P-8118). In addition, the strength of the base paper is preferably 20 to 200 g under the conditions of JIS P-8143.

A surface size agent may be coated on the surface of the base paper, and a size agent which is the same as size which can be added to the base paper can be used as the surface size agent. It is preferable that the pH of the base paper is 5 to 9 when measured by a hot water extraction method provided by JIS P-8113.

In general, the both front and back surfaces of the base paper can be coated with polyethylene. Main examples of polyethylenes include low density polyethylene (LDPE) and/or high density polyethylene (HDPE) but others such as LLDPE and polypropylene can be also used in part.

Especially, in the polyethylene layer on the side on which the ink receiving layer is formed, it is preferable that rutile type or anatase type titanium oxide, an optical brightening agent or ultramarine blue pigment are added to polyethylene, and thereby the degree of opaqueness, whiteness and color are improved, as is widely performed for printing papers for photographs. Herein, the content of titanium oxide is preferably about 3 to 20% by mass, and more preferably 4 to 13% by mass to polyethylene. The thickness of the polyethylene layer is not limited to a particular thickness, and more preferably 10 to 50 μm. Further, an undercoat layer can be formed to give adhesion of the ink receiving layer on the polyethylene layer. Water polyester, gelatin, and PVA are preferably used as the undercoat layer. The thickness of the undercoat layer is preferably 0.01 to 5 μm.

A polyethylene coated paper sheet may be used as glossy paper, or when polyethylene is coated on the base paper sheet by melt-extrusion a matte surface or silk finish surface may be formed by applying an embossing treatment, as obtainable in usual photographic printing paper sheets.

On the support body a back coat layer can be provided, and white pigments, water soluble binders and other components can be used as additive components of the back coat layer.

Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include defoaming agents, foaming suppressing agents, dyes, optical brighteners, preservatives and water-proofing agents.

(Inkjet Recording Medium Production)

The ink receiving layer of the inkjet recording medium of the invention is preferably formed by a so called “Wet on Wet” method of cross-linking curing of a coating layer by: application of a coating layer containing at least an aqueous dispersion of the self-emulsifying polymer of the invention and a water soluble resin (the first coating liquid) onto a surface of the support body; adding a cross-linking agent to the coating liquid (first coating liquid) and/or to a basic liquid (the second coating liquid), having a pH value of 7.1 or above; and applying the second coating liquid onto the coating layer formed by the first coating liquid, at either (1) the same time as forming the coating layer by applying coating liquid A, or (2) during the drying of the coating layer formed by applying coating liquid A and before the coating layer exhibits a decrease in the drying rate.

The above cross-linking agent for obtaining cross-linking of the water soluble resin, is preferably added to one or both of the above first coating liquid or second coating liquid. Forming cross-linking of the ink receiving layer in this way by applying the basic liquid (second coating liquid) to the first coating liquid at the above times of (1) the same time, or (2) during drying is particularly preferable to improve the appearance, from the perspective of the ink absorption ability and prevention of cracks in the film, as well as cissing defects.

The aqueous dispersion material of the self-emulsifying polymer of the invention in the ink receiving layer is added to at least one of the first coating liquid and/or the second coating liquid (basic liquid). However, from the perspective of sufficiently mixing with the fine particles and the water soluble resin of the first coating liquid in order to effectively prevent the occurrence of bleeding with lapse of time, an embodiment in which the aqueous dispersion material of the self-emulsifying polymer is included in the first coating liquid (the coating liquid including the fine particles and water soluble resin) is preferable. In this case, it is not always necessary that all of the aqueous dispersion material of the above self-emulsifying polymer is included in the first coating liquid, and it is also effective to include at least a portion of the aqueous dispersion material of the above self-emulsifying polymer of the invention in the second coating liquid. By so doing the occurrence of bleeding with lapse of time can be effectively prevented. An embodiment is also preferable in which at least a portion of the aqueous dispersion material of the self-emulsifying polymer of the invention is included in both of the first and second coating liquids.

The mordant is included such that a thickness from the surface of the ink receiving layer of the portion containing the mordant accounts for preferably 10 to 60% of the total thickness of the ink receiving layer. For example, either of these methods can be selected: (1) forming a coating layer containing the fine particles and the water-soluble resin or cross-linking agent, followed by coating a mordant-containing solution thereon; or (2) multi-coating, by applying the coating liquid containing the fine particles and water-soluble resin or cross-linking agent, at the same time as coating the mordant-containing solution. Also, inorganic fine particles, water-soluble resin and cross-linking agent may be added to the mordant-containing solution. Forming by the above methods is preferable since significant amount of mordant is then present in a specific portion of the ink receiving layer, and so the ink coloring material of the inkjet can be sufficiently mordanted, and the color density, the tendency to bleed with the lapse in time, glossiness of the printed areas, the water resistance of text and images after printing, and the resistance to ozone can be further improved. A portion of the mordant can contained in a layer provided at first on the support body. In this case the mordant applied later can be the same mordant or a different mordant.

The coating liquid in the invention of the first coating liquid, containing inorganic pigment fine particles and water soluble resin or a boron compound (cross-linking agent), can be prepared as set out below.

Silica fine particles with a uniform average particle diameter of 20 nm or below can be added to water (for example, to a silica fine particle concentration in water of 10 to 20% by mass), dispersing the fine particles using a high speed rotational wet-type colloid mill (such as trade name: Clearmix, manufactured by M Technique Co., Ltd.) at a high speed rotation of 10,000 rpm (preferably, at 5,000 to 20,000 rpm) for 20 minutes (preferably, for 10 to 30 minutes), then adding a boron compound (for example at a rate of 0.5 to 20%, relative to the silica by mass), dispersal under the same conditions as above, adding an aqueous polyvinyl alcohol (PVA) solution (to make the PVA concentration become about ⅓ of the concentration of the silica), and again dispersing under the same conditions as described above. The thus obtained coating liquid is in the state of a sol, and a porous ink receiving layer having a three-dimensional network structure can be formed by applying the solution onto the support by the method described below.

Where necessary pH adjusting agents, a dispersants, surfactants, anti-foaming agents, anti-static agents and the like can be added to the above first liquid.

Dispersing machines used for the dispersion include various known dispersing machines such as a high speed rotational dispersing machine, medium agitating-type dispersing machine (such as a ball mill and a sand mill), ultrasonic dispersing machine, colloid mill dispersing machine and high pressure dispersing machine. However, the medium agitating-type dispersing machine, colloid mill dispersing machine and high pressure dispersing machine are preferable for efficiently dispersing coagulates of the fine particles.

Water, organic solvents and mixed solvents thereof may be used as the solvent in each step. Examples of the organic solvent used for preparing a coating solution include alcohols such as methanol, ethanol, n-propanol, i-propanol and methoxypropanol, ketones such as acetone and methylethyl ketone, tetrahydrofuran, acetonitrile, ethyl acetate and toluene.

The surfactant included in the second coating liquid (basic liquid) can, for example, be adjusted as set out below. That is, mordant (for example 0.1 to 5.0% by mass) and surfactants (for example to a total amount of 0.01 to 1.0% by mass) and, where required, cross-linking agent (0 to 5.0% by mass) can be added to ion exchange water and agitated sufficiently. The pH of the second coating liquid is preferably more than 8.0, and by using pH adjusters such as aqueous ammonia, sodium hydroxide, potassium hydroxide, amine group containing compounds (such as ethylene, ethanol amine, diethanol amine, polyallylamine) the pH can be set to 8.0 or above.

The first coating solution (coating solution of the ink receiving layer) can be coated by a known method, such as using an extrusion die coater, an air doctor coater, a blade coater, a rod coater, a knife coater, a squeeze coater, a reverse roll coater, or a bar coater.

While the second coating solution (basic coating solution) is applied on the coating layer simultaneously with or after applying the first coating solution (coating solution for ink receiving layer), the second coating solution may be applied before the coating layer exhibits a fall in the rate period of drying. In other words, the ink receiving layer is favorably formed by providing the basic coating solution before the coating layer exhibits falling rate of drying after applying the first coating solution for the ink receiving layer. A mordant may be added to the second coating solution.

The phrase “before the coating layer exhibits a falling rate of drying” usually means a process within several minutes from immediately after applying the coating solution of the ink receiving layer. During this period the content of the solvent (dispersing medium) in the applied coating solution decreases in proportion to the lapse of time (a constant rate period of drying). The time lapse exhibiting “constant rate period of drying” is described, for example, in Kagaku Kogaku Binran (Chemical Engineering Handbook), pp.707-712, Maruzen Co. Ltd., 25 Oct. 1980.

The period in which the coating layer is dried until it exhibits a falling rate of drying after applying coating solution A, is usually, at 50 to 180° C., for 0.5 to 10 minutes (preferably, 0.5 to 5 minutes). While this drying time differs depending on the amount of coating, the aforementioned range is usually appropriate.

Examples of the method for applying the coating solution before the first coating layer exhibits a falling rate period of drying include (1) further coating the second coating solution on the coating layer, (2) spraying the second coating solution, and (3) dipping the support on which the coating layer has been disposed in the second coating solution.

The method used for applying coating solution 2 in the above method (1) includes known application method using, for example, a curtain flow coater, an extrusion die coater, an air doctor coater, a blade coater, a rod coater, a knife coater, a squeeze coater, a reverse roll coater and a bar coater. The extrusion die coater, curtain flow coater or bar coater is preferably used to prevent the coater from contacting with the already formed first coating layer.

The coating amount of the second coating liquid is generally 5 to 50g/m²,and preferably 10 to 30g/m².

After application of the second coating liquid, generally drying and curing is carried out at 40 to 180° C. for 0.5 to 30 minutes. Heating at a temperature of 40 to 150° C. for 1 to 20 minutes is preferable. For example, when borax or boric acid is included in the first coating liquid as a cross-linking agent, then carrying out heating to a temperature of 60 to 100° C. for 5 to 20 minutes is preferable.

When the basic solution (coating solution 2) is applied simultaneously with applying the coating solution (coating solution 1) for the ink receiving layer, coating solutions 1 and 2 are simultaneously provided on the support so that coating solution 1 contacts the support (multi-layer coating), and then the solutions are dried to thereby form the ink receiving layer.

Coating methods using, for example, an extrusion die coater or a curtain flow coater may be employed for simultaneous application (multilayer coating). When the coated layers are dried after the simultaneous coating, these layers are usually dried by heating at 40 to 150° C. for 0.5 to 10 minutes, and preferably by heating at 40 to 100° C. for 0.5 to 5 minutes.

When the coating solutions are simultaneously applied (multi-layer coating) using, for example, an extrusion die coater, the simultaneously supplied two coating solutions are laminated at near the outlet of the extrusion die coater, or immediately before the solutions are transferred onto the support, and are laminated on the support to make a dual layer. Since the two layers of the coating solutions laminate before application onto the support, they tend to undertake cross-linking at the interface between the two solutions while the solutions are transferred onto the support. This results in the supplied two solutions readily become viscous by being mixed with each other in the vicinity of an outlet of the extrusion die coater, occasionally leading to trouble in the coating operation. Accordingly, it is preferable to simultaneously arrange triple layers by presenting a barrier layer solution (intermediate layer solution) between the solution 1 and solution 2, at the same time as applying of the coating solutions 1 and 2.

The barrier-layer solution can be selected without particularly limitations, and examples thereof include an aqueous solution containing a trace amount of water-soluble resin, water, and the like. The water-soluble resins are used considering the coating property of the solution, for example, for increasing the viscosity of the solution, and examples thereof are polymers including cellulosic resins (e.g., hydroxypropylmethylcellulose, methylcellulose, hydroxyethylmethyl cellulose, and the like), polyvinylpyrrolidone, gelatin, and the like. The barrier-layer solution may also contain a mordant.

After forming on the support, the ink receiving layer may be subjected to calendering by passing through roll nips under heat and pressure, for example, by using a super calender or gloss calender, or the like, for improvement in the surface smoothness, glossiness, transparency, and strength of the coated film. However, because calendering sometimes causes decrease in void ratio (i.e., decrease in ink absorptive property), it is necessary carry out calendering under conditions set to reduce the decrease in void percentage.

The roll temperature during calendering is preferably 30 to 150° C. more preferably 40 to 100° C., and the linear pressure between rolls during calendering is preferably 50 to 400 kg/cm and more preferably 100 to 200 kg/cm.

In the invention the thickness of the ink receiving layer should be decided, in the case of inkjet recording, according to the void percentage of the layer, as the layer should have a sufficient absorption capacity allowing absorption of all droplets. For example, if the ink quantity is 8 nl/mm² and the void percentage is 60%, a film having a thickness of about 15 μm or more is required. Considering the above, ink receiving layer for ink jet recording preferably has a thickness of 10 to 50 μm.

In addition, the median diameter of the pores in the ink receiving layer is preferably 0.005 to 0.030 μm, and more preferably 0.01 to 0.025 μm. The void percentage and the pore median size may be determined by using a mercury porosimeter (trade name: “Poresizer 9320-PC2”, manufactured by Shimadzu Corporation).

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

### EXAMPLES

The invention will now be explained with reference to specific Examples below, however the invention is not limited by these examples. In the Examples “parts”, and “%” refer to parts by mass or mass %, and “degree of polymerization” refers to the weight average degree of polymerization, unless otherwise stated.

### Example 1

(Support Body Manufacture)

50 parts of LBKP derived from acacia and 50 parts of LBKP derived from aspen are each processed by beating in a disc refiner until the Canadian freeness is 300 ml.

To the obtained pulp slurry is added, relative to the pulp, 1.3% of cationic starch (trade name:CATO 304L; manufactured by National Starch and Chemical Japan), 0.15% anionic polyacrylamide (trade name: POLYACRON ST-13, manufactured by Seiko PMC Corporation), 0.29% alkyl ketene dimer (trade name: Sizepine K, manufactured by Arakawa Chemical Industries), 0.29% epoxidated behenic acid amide, and 0.32% polyamide-polyamine-epichlorohydrine (trade name: Arafix 100; manufactured by Arakawa Chemical Industries). Following that 0.12% of an anti-foaming agent is added.

The above prepared pulp slurry is then made into paper using a Fourdrinier paper machine, and in a drying process the felt surface of the web is pressed against a drum dryer via a dryer canvas, with the dryer canvas tension adjusted to 1.6 kg/cm. After drying, the base paper is size pressed on both surfaces with polyvinyl alcohol (trade name: KL-118; manufactured by Kuraray Company Ltd.) coated at rate of 1 g/m², dried, and calender processed. The base paper manufactured has a basis weight of 166 g/m and a base paper (substrate paper) with a thickness of 160 μm is obtained.

After undertaking corona electrical discharge treatment of the wire surface (back surface) of the substrate paper, the surface is coated to a thickness of 30 μm with high density polyethylene using a melt extrusion machine, and the thermoplastic resin layer is formed on what was the matt surface (from now on this thermoplastic resin layer surface will be referred to as the ‘back surface’). Further corona electrical discharge treatment is carried out on this back surface. Then, as an anti-static agent, aluminium oxide (trade name: Aluminasol 100; manufactured by Nissan Chemical Industries Ltd) and silicon dioxide (trade name: Snowtex 0; manufactured by Nissan Chemical Industries Ltd) at a mass ratio of 1:2 is dispersed in water to form a treatment liquid and coated to a dry weight of 0.2 g/m². Continuing, the front surface is corona treated, and using a melt extrusion machine coated to 24g/m² with polyethylene containing titanium oxide 10% by mass of a density 0.93 g/cm³.

(Preparation of the Coating Liquid for Forming the Ink Receiving Layer (First Liquid))

From the components described below the (1) vapor-phase silica fine particles, (2) ion exchange water, (3) Shallol DC-902P, and (4) ZA-30 are mixed, and using a bead mill (trade name: KD-P; manufactured by Shimaru Enterprises Corp.), dispersed. After dispersion, the dispersion liquid is heated to 45° C. and then kept for 20 hours. After this the below (5) boric acid, (6) dimethyl amine-epichlorohydrin-polyalkylene polyamine condensate compound, (7) polyvinyl alcohol solution, (8) Superflex 600, and (9) ethanol are added at 30° C. to prepare the ink receiving layer coating liquid (first liquid).

<Composition of the ink receiving layer coating liquid>

| | | |
|---|---|---|
| (1) vapor-phase silica fine particles | 10 | parts |
| (trade name: AEROSIL 300 SF75; manufacturer Nippon | | |
| Aerosil) | | |
| (2) ion exchange water | 58.5 | parts |
| (3) Dispersing agent 51.1% solution | 0.8 | parts |
| (trade name: Shallol DC-902P; manufactured by | | |
| Daiichi Kogyo Seiyaku) | | |
| (4) Zirconyl Acetate | 0.5 | parts |
| (trade name: ZA-30; manufactured by Daiichi | | |
| Kigenso Kagaku Kogyo Co. Ltd) | | |
| (5) Boric Acid (cross-linking agent) | 0.30 | parts |
| (6) dimethyl amine - epichlorohydrin - polyalkylene | 0.2 | parts |
| polyamine condensate compound | | |
| (trade name: SC-505; manufactured by Hymo Co. | | |
| Ltd; 50% solution) | | |
| (7) polyvinyl alcohol solution | 26.34 | parts |

<Polyvinyl alcohol solution composition>

| | | |
|---|---|---|
| (1) | Polyvinyl alcohol | 1.8 parts |
| | (Trade name: PVA235; manufactured by Kuraray | |
| | Company Ltd; degree of saponification 88%, degree | |
| | of polymerization 3500) | |
| (2) | Polyoxyethylene laurylether (surfactant) | 0.06 parts |
| | (Trade name: Emulgen 109P; manufacturer Kao | |
| | Corporation) | |
| (3) | Compound 1 as below | 0.1 parts |
| (4) | Diethylene glycol monobutyl ether | 0.6 parts |
| (5) | Ion exchange water | 23.78 parts |
| (8) | Cationic modified polyurethane | 2.2 parts |
| | (Trade name: Superflex 600; manufactured by Daiichi | |
| | Kogyo Seiyaku) | |
| (9) | Ethanol | 2.3 parts |
| | 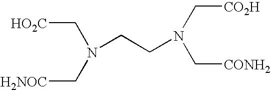 | |
| | (Inkjet recording sheet manufacture) | |

After electrical discharge corona treatment of the front surface of the support body prepared as above, then coating is carried out with a flow of the above ink receiving layer so as to form a coating layer of 173ml/m², and using in-line mixing with a polychloride aluminum aqueous solution dilute to 5 fold (Trade name: Alufine 83; manufactured by Taimei Chemicals Co. Ltd.) with a speed of 10.8 ml/m². This is then dried until the solid content of the coating layer is 20% using a heated drying machine at 80° C. (air speed between 3 and 8 m/s). This coated layer exhibits a constant rate of drying during this period. Before the drying rate decreases, the basic liquid (pH=7.9) of the composition described below is applied to the ink receiving layer and allowed to soak in for a period of 3 seconds to achieve an application rate of 13 g/m². Then further drying is carried out at 80° C. for 10 minutes (curing process). As a result of this an ink receiving layer (recording layer) is coated giving a dry film thickness of 32 μm.

<Basic liquid composition>

| | | |
|---|---|---|
| (1) Boric acid | 0.65 | parts |
| (2) Zirconium ammonium carbonate (28% solution) | 0.33 | parts |
| (trade name: Zircosol AC-7, manufactured by Daiichi | | |
| Kigenso Kagaku Kogyo Co. Ltd) | | |
| (3) Ammonium carbonate | 3.5 | parts |
| (1^{st} Grade, Kanto Kagaku) | | |
| (4) Ion exchange water | 63.3 | parts |
| (5) Polyoxyethylene laurylether (surfactant) | 30.0 | parts |
| 2% solution | | |
| (Trade name: Emulgen 109P; manufacturer | | |
| Kao Corporation) | | |

The inkjet recording sheets of Examples 2 to 4 were manufactured in the same way as Example 1, except in that the type of cationic modified polyurethane was changed as indicated in Table 1.

### Comparative Example 1

The inkjet recording sheet of Comparative Examples 1 was manufactured in the same way as Example 1, except in that the no cationic modified polyurethane was added to the ink receiving layer coating liquid, nor was polychloride aluminium in-line mixed, and further neither in compositions of the ink receiving layer coating liquid nor the basic coating liquid (second coating liquid) was ZA-30 (zirconyl acetate) or ammonium zirconium carbonate included.

(Evaluation and Testing)

The inkjet recording sheets obtained above were subject to the evaluation and testing as described below, the result of which are shown in Table 1.

(1) Bleeding which Occurs with the Passage of Time

An image of adjacent lattice like lines of magenta and black (line width 0.28 mm) was printed as an image on each of the above inkjet recording sheets using a PM970C inkjet printer manufactured by Epson Corporation. The sample images where then into transparent polypropylene file sleeves and held at a temperature of 35° C. and relative humidity of 80% for 3 days. Then the optical density of the lattice like areas of magenta and black were visually examined, and the occurrence of bleeding with the passage of time was evaluated by calculating the change coefficient.

Also, in a similar way, blue lattice patterns (line width 0.28 mm) were printed on each of the inkjet recording sheets using a Pixus 850i inkjet printer, manufactured by Cannon Corporation, and evaluation was carried out in the same way.

The optical density was measured in each case using a Xrite 938.

The evaluation was according to the criteria below.

A: Less than 50%
C: 50% or more.
   (2) Coating Condition
   Evaluation was made of the coating condition by counting the number of cracks of 30 μm or more, and using the criteria below.
A: no cracks per m²
B: 1 to 15 cracks per m²
C: more than 15 cracks per m²
   (3) Curl

Inkjet recording sheets were humidified by kept at 10° C. and 20% relative humidity for a period of 24 hours, the lift recorded in the four comers of the sheets was measured, and the average value was calculated.

TABLE 1

| | Cationic | | | | | |
|---|---|---|---|---|---|---|
| | modified | Water soluble | Bleeding | | | |
| | Polyurethane | multi-valent | PM | Pixus | Coating | |
| | (Tg) | metal salts | 970C | 850i | condition | Curl |
| Example 1 | Superflex 600 | Aluminium polychloride | A | A | B | +2 mm |
| | (70° C.) | Zirconyl acetate | | | | |
| | | Ammonium zirconium | | | | |
| | | Carbonate | | | | |
| Example 2 | Superflex 610 | Aluminium polychloride | A | A | A | −1 mm |
| | (−12° C.) | Zirconyl acetate | | | | |
| | | Ammonium zirconium | | | | |
| | | Carbonate | | | | |
| Example 3 | Superflex 620 | Aluminium polychloride | A | A | A | 0 mm |
| | (48° C.) | Zirconyl acetate | | | | |
| | | Ammonium zirconium | | | | |
| | | Carbonate | | | | |
| Example 4 | Superflex 600 | Aluminium polychloride | A | A | A | −1 mm |
| | (−17° C.) | Zirconyl acetate | | | | |
| | | Ammonium zirconium | | | | |
| | | Carbonate | | | | |
| Comparative | None | None | C | C | C | −2 mm |
| Example 1 | | | | | | |

What is claimed is:

1. An inkjet recording medium comprising a support body on which is provided an ink receiving layer wherein:
the ink receiving layer is formed by using a coating liquid which comprises at least one type of water-soluble multi-valent metal salt and an aqueous dispersion of a cation modified self-emulsifying polymer compound, wherein the aqueous dispersion is an aqueous dispersion of a cationic urethane resin with a glass transition temperature of less than 50 ° C., and has an average particle size of 0.05 μm or less.

2. The inkjet recording medium of claim 1, wherein the ink receiving layer further comprises at least one compound selected from the group containing polyvinyl alcohol based resins, cellulose based resins, resins with ether bonds, resins with carbamoyl groups, resins with carboxyl groups and gelatins.

3. The inkjet recording medium of claim 1, wherein the ink receiving layer further comprises fine particles.

4. The inkjet recording medium of claim 2, wherein the ink receiving layer further comprises fine particles.

5. The inkjet recording medium of claim 3, wherein the fine particles are fine particles selected from the group consisting of organic fine particles, silica fine particles, colloidal silica fine particles, alumina fine particles and pseudo boehmite hydrate aluminum fine particles.

6. The inkjet recording medium of claim 4, wherein the fine particles are fine particles selected from the group consisting of organic fine particles, silica fine particles, colloidal silica fine particles, alumina fine particles and pseudo boehmite hydrate aluminum fine particles.

7. The inkjet recording medium of claim 1, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

8. The inkjet recording medium of claim 2, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

9. The inkjet recording medium of claim 3, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

10. The inkjet recording medium of claim 4, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

11. The inkjet recording medium of claim 5, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.

12. The inkjet recording medium of claim 6, wherein the ink receiving layer is: a coating layer, from coating with a coating liquid containing at least fine particles and water soluble resin, which is cross-link cured; and the cross-link curing is carried out by applying a basic liquid of pH 7.1 or higher to the coating layer either (1) at the same time as the coating layer is formed by coating with the coating liquid or (2) during the period when the coating layer, from coating with the coating liquid, is drying and before the coating layer shows a decreasing rate of drying.
